(19) United States
(12) Patent Application Publication
(10) Pub. No.: US 2006/0171335 A1
(43) Pub. Date: Aug. 3, 2006

(54) Backup channel selection in wireless LANs

(76) Inventors: Michael Yuen, Waltham, MA (US); Roger Durand, Amherst, NH (US); David R. Hill, Holden, MA (US)

Correspondence Address: McGUINNESS & MANARAS LLP, 125 NAGOG PARK, ACTON, MA, 01720, US

(21) Appl. No.: 11/103,403

(22) Filed: Apr. 11, 2005

Related U.S. Application Data
(60) Provisional application No. 60/649,799, filed on Feb. 3, 2005.

(51) Int. Cl. H04L 12/28

(52) U.S. Cl. 370/255

(57) ABSTRACT

Potential alternate channels in a wireless network are periodically analyzed and ranked in terms of interference. The best ranked alternate channel is selected as the new operating channel if a decision is made to move from the current operating channel to an alternate channel. Because the potential alternate channels are pre-ranked, the move to the new channel can be executed relatively quickly, and with reduced risk of encountering unacceptable interference conditions. Various ranking categories may be used, including but not limited to a first category that is relatively free of interference, a second category that has some interference but will support degraded communications, and a third category that has an unacceptable level of interference. Within a given rank, preference may be given to channels that were most recently analyzed and ranked.

### CROSS-REFERENCE TO RELATED APPLICATIONS

A claim of priority is made to U.S. Provisional Patent Application Ser. No. 60/649,799, entitled Interference Counter Measures for Wireless LANs, filed Feb. 3, 2005, which is incorporated herein by reference.

### FIELD OF THE INVENTION

This invention is generally related to wireless communications, and more particularly to coping with interference in a wireless communications network.

### BACKGROUND OF THE INVENTION

Certain wireless local area network (“WLAN”) products, such as products based on the IEEE 802.11 standard, operate in unregulated spectrum. One problem associated with operating in unregulated spectrum is the potential of encountering interference from other devices. Regulated spectrum is relatively free of interference because unlicensed products which operate in the regulated spectrum can be removed from the marketplace. Even in unregulated spectrum there is at least a possibility of negotiating strategies for coping with interference from standards-compliant devices via standards organizations. However, some of the potential interfering devices are not standards-compliant, and some are not even communications devices. There is therefore a need for techniques and devices for coping with interference in unregulated spectrum.

### SUMMARY OF THE INVENTION

A technique for coping with interference in a wireless network includes analyzing a plurality of alternate operating channels; ranking the alternate operating channels according to interference detected when analyzing the channels; and if a decision is made to move to an alternate operating channel, selecting the best ranked alternate operating channel. Various ranking categories may be used, including but not limited to a first category that is relatively free of interference, a second category that has some interference but will support degraded communications, and a third category that has an unacceptable level of interference. Within a given rank, preference may be given to channels that were most recently analyzed and ranked.

The invention helps improve communications by facilitating timely selection of an alternate channel. Different interference sources may have significantly different effects on communications with a spectrum. For example, some interference sources are relatively localized to a particular channel, whereas other interference sources adversely effect multiple channels. Similarly, some interference sources exhibit relatively higher power, longer pulse duration, or longer pulse period. Hence, it is not always possible to avoid interference simply by moving to a different channel. While it might be possible to implement a heuristic technique that moves sequentially to various different channels until an acceptable channel is located, the delay associated with finding a suitable channel could be disruptive to communications. By analyzing interference on various channels and ranking those channels before the need to change channels arises, it may be possible to move directly to the best available channel and thereby reduce the delay and associated communication disruption associated with changing channels.

### BRIEF DESCRIPTION OF THE FIGURES

FIG. 1 illustrates a wireless access point and end station adapted for coping with interference.

FIG. 2 is a flow diagram illustrating a technique for coping with interference.

FIG. 3 illustrates aspects of an interference waveform.

FIG. 4 illustrates channel ranking.

FIG. 5 illustrates selection of an alternate channel from a table of ranked alternate channels.

### DETAILED DESCRIPTION

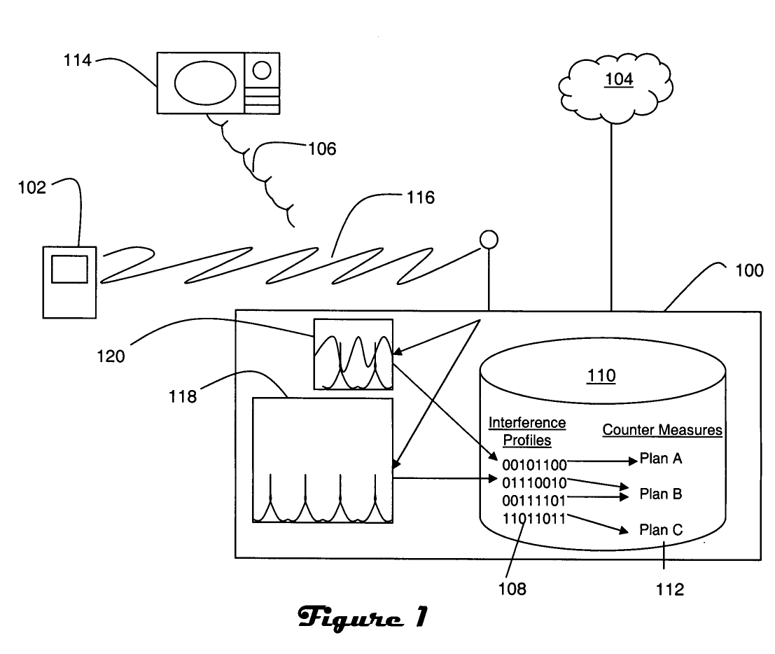

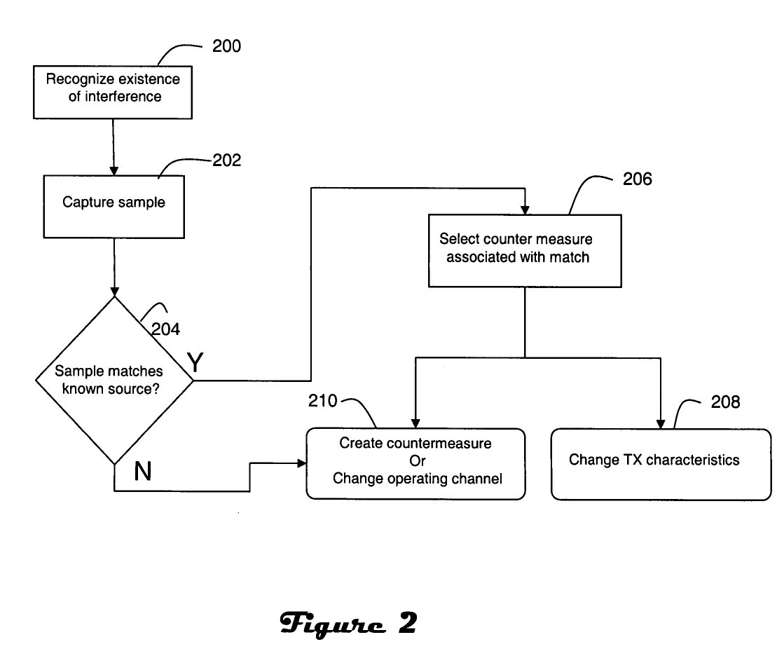

Referring to FIGS. 1 and 2, a wireless access point (100) is operative to provide network access to a wireless end station (102) such as a personal computer, PDA, notebook computer or phone. The end station (102) is typically a mobile device without wireline connections, whereas the access point (100) is typically a stationary device having a wireline connection with another network device such as switch, router or server in a network (104). Communications between the access point (100) and the end station (102) are typically two-way, and may utilize one or more channels within a predefined spectrum.

The access point (100) is adapted to recognize and respond to interference (106) generated by a device (114) other than the end station (102). For example, the access point includes a table (108) of interference profiles in memory (110) which are indicative of particular sources of interference. The memory (110) also includes a table (112) of counter measure plans which specify actions to be taken when a particular source of interference is recognized. Each counter measure plan specifies at least one remedial action, such as altering transmission characteristics and changing to an alternate communication channel. The remedial actions may be arranged hierarchically such that multiple actions are attempted in a predefined order until a satisfactory result is obtained. Each interference profile in the table (108) is associated with at least one counter measure plan in the corresponding table (112), and multiple interference profiles may be associated with a particular counter measure plan.

The first step (200) in the technique employed by the access point (100) to cope with interference is recognizing the existence of the interference (106). The access point may recognize the interference by analyzing the signal received at the access point. For example, a quiet interval may be implemented such that the signal received at the access point does not include normal traffic (116) between the access point and end station, but rather comprises any existing interference, e.g., signal (106). An alternative to use of the quiet interval is to analyze the combination of normal traffic signal (116) and interference signal (106). For example, a parallel demodulation engine (120) may be programmed to identify, from the combined signal, types of interference that differ recognizably from actual data in the channel. Alternatively, recognition of a combined signal which has a relatively high proportion of noise or is not in a format specified by the communications protocol being utilized may be used as an indication of the presence of interference. Alternatively, some communications protocols specify use of periodic communications between an access point and end station primarily to verify that the communications link is operational. Such a protocol may also be used to recognize the existence of interference when the communications link fails for purposes of the present technique.

Once the access point recognizes the existence of interference it then captures a sample (118) of the interference as indicated in step (202) in order to attempt to identify the source of the interference. The sample may be captured by storing a portion of the interference signal (106) received at the access point. The received signal, which is analog, may then be sampled and converted to digital format for processing. Each sample measurement is associated with a time stamp indicating the relative time at which the sample was obtained. Hence, the resulting data comprises sets of energy magnitude measurements and time stamps.

Because there are different possible sources of interference, and the characteristics of the interference associated those sources may vary, the sampling rate and period are selected to capture a sufficient sample to identify all known potential sources of interference stored in the digital patterns in memory. The sample (118) is then compared with the interference profiles in table (108) to identify a match, or the absence of a match, as indicated by step (204). Alternatively, an adaptive algorithm may be employed to adjust the sampling period and rate until a match between the sample and an interference profile is located or eliminated as a possibility. If a matching interference profile is located in table (108) then the associated counter measures plan is selected as indicated by step (206). As discussed above, the counter measures plan may include one or more of changing transmission signal characteristics as indicated by step (208) and changing to an alternate operating channel, or creating a countermeasure based on the interference signal, as indicated by step (210). If no matching interference profile is located then the access point either creates a counter measure based on the interference sample or changes to the alternate operating channel as indicated by step (210).

The quiet interval may be implemented by various techniques. For example, a continuous quiet interval may be implemented by temporarily ceasing communications until a sample of sufficient duration is obtained. Alternatively, temporally non-contiguous quiet gaps between communications may be combined via a relatively long sampling window during which the probability of having a continuously occupied channel over the entire time period is near zero to assemble a quiet interval.

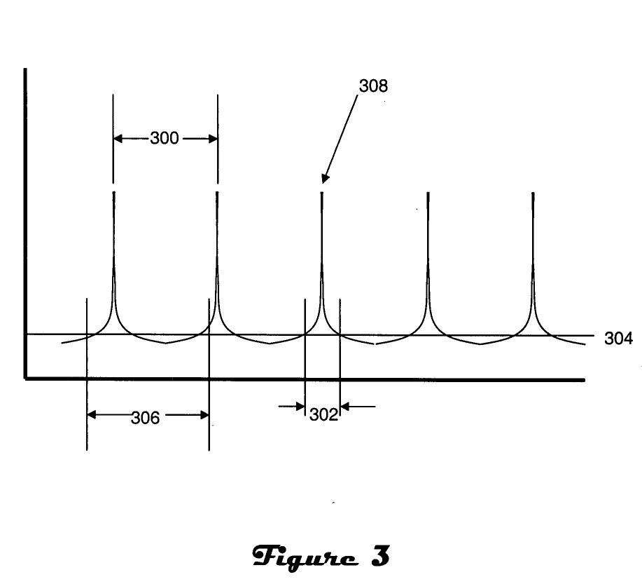

Referring to FIGS. 1 and 3, the samples (118) are primarily characterized in terms of pulse duration (302), although pulse period (300) may also be employed to differentiate between interference sources. Pulse period (300) is indicative of the time between consecutive pulses, and pulse duration (302) is indicative of the time during which an individual pulse exhibits a power level above a predetermined threshold, i.e., sampling noise floor (304). After gathering multiple data points across a sample window (306), parallel processes are executed to calculate interference signal duration and period. Initially, the point of maximum energy (“peak”) (308) in the sample window is identified. Once the peak is identified, an energy level “time width” on either side of the peak energy point is identified by finding the first samples on both sides that drop to the measurement noise floor (304) on each side of the peak (308). Contemporaneously with the interference duration calculation an interference signal period calculation is executed by identifying corresponding peaks, and then calculating the time between consecutive peaks.

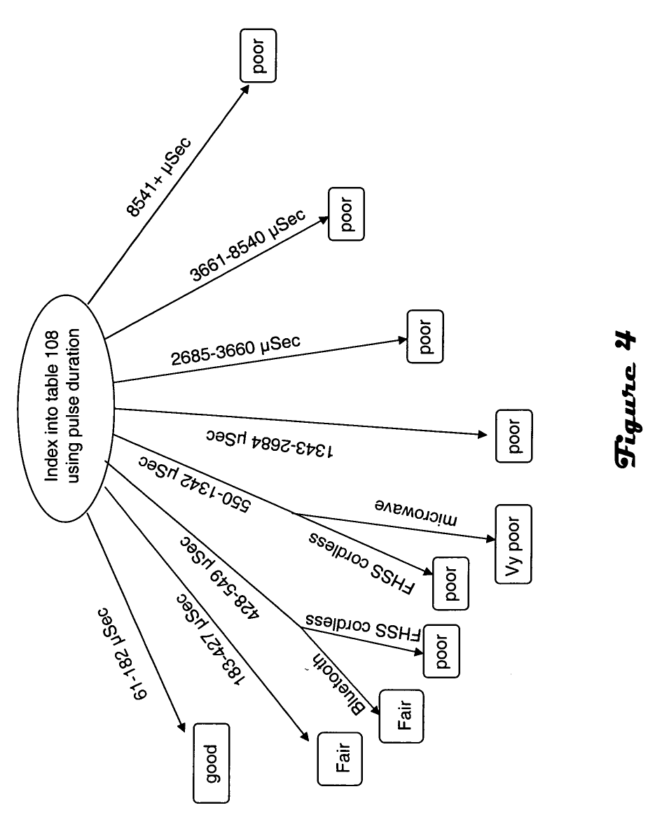

Referring now to FIGS. 1 and 4, the techniques described above for analyzing the active channel are applied to potential alternate channels in order to pre-rank those alternate channels for selection in the event of a channel change. Analysis of potential alternate channels is executed periodically in order to recognize and account for changing conditions within the operating spectrum. While each potential alternate channel could be continuously monitored, it may be more cost effective to analyze and rank the potential alternate channels individually in sequence. The analysis of potential alternate channels may be executed by a parallel demodulation engine or by temporarily changing channels with a primary demodulation engine during quiet intervals.

For each potential alternate channel, the pulse duration of the sample from that channel is employed as an index into table (108). Table (108) includes ranking information for various known types of interference. In the illustrated example the channels are ranked as “good,” “fair,” or “poor.” The rank “good” may be indicative of a channel which is relatively free of interference. The rank “fair” may be indicative of a channel which has interference but may nevertheless support communications. The rank “poor” may be indicative of a channel which has interference and is unlikely to support communications at a reasonable data rate.

If the pulse duration is in the range of 61-182 μSec then the channel is ranked as a “good” potential alternate. There is a probability that interference characterized by this pulse duration range is a result of switching transients internal to the access point (100).

If the pulse duration is in the range of 183-427 μSec then the channel is ranked as “fair.” An interference pulse duration in the range of 183-427 μSec is indicative of a Bluetooth product. Bluetooth products operate at relatively low power levels throughout the 2.4 GHz band. Hence, increasing transmission power is generally more effective at mitigating the effects of the interference than changing channels.

If the pulse duration is in the range of 428-549 μSec then the channel is ranked as “fair.” Interference exhibiting a pulse duration in this range may be from a Bluetooth product or a short-sync pulse from a FHSS cordless phone base station. If it is possible to differentiate between a Bluetooth product and FHSS cordless phone as the source then the channel is ranked as “fair” in the case of a Bluetooth source, and “poor” in the case of a FHSS cordless phone base station source.

If the pulse duration is in the range of 550-1342 μSec then the channel is ranked as “poor.” An interference source exhibiting a pulse duration within this range is likely a FHSS cordless phone, although it may also be a microwave source on an adjacent or more distant channel. The sample (118) may be examined more closely to distinguish between the microwave and FHSS cordless phone. In the case of the FHSS cordless phone the peak is relatively flat and the pulse duration is in the range of 625-950 μSec, increasing in proportion to the number of handsets. Conversely, if the peak rolls off in power more than 5 dB the source is probably microwave, particularly if the pulse duration is at the higher part of the range. If it is possible to distinguish whether the interference source is a FHSS cordless phone or microwave then an even lower quality rank, e.g., “vy poor,” may be applied to the channel if the source is a microwave.

If the pulse duration is in the range of 1343-2684 μSec then the channel is ranked as “poor.” An interference source exhibiting a pulse duration within this range is likely a microwave on an adjacent channel. Pulse period may be employed to obtain data further supporting identification of the source as microwave. In particular, a single pulse microwave fires once every AC cycle whereas a double pulse microwave fires twice every AC cycle. Hence, local power standards and the measured pulse period can be employed to produce corroborating data.

If the pulse duration is in the range of 2685-3660 μSec then the channel is ranked as “poor.” An interference source exhibiting a pulse duration within this range can be a microwave that is straddling the channel if it is single pulse, or a microwave in the channel if it is double pulse.

If the pulse duration is in the range of 3661-8540 μSec then the channel is ranked as “poor.” An interference source exhibiting a pulse duration within this range is most likely a single pulse microwave in channel.

If the pulse duration is above 8541 μSec then the channel is ranked as “poor.” An interference source exhibiting a pulse duration within this range is a CW interferer such as a video camera, cordless phone, or video delivery system.

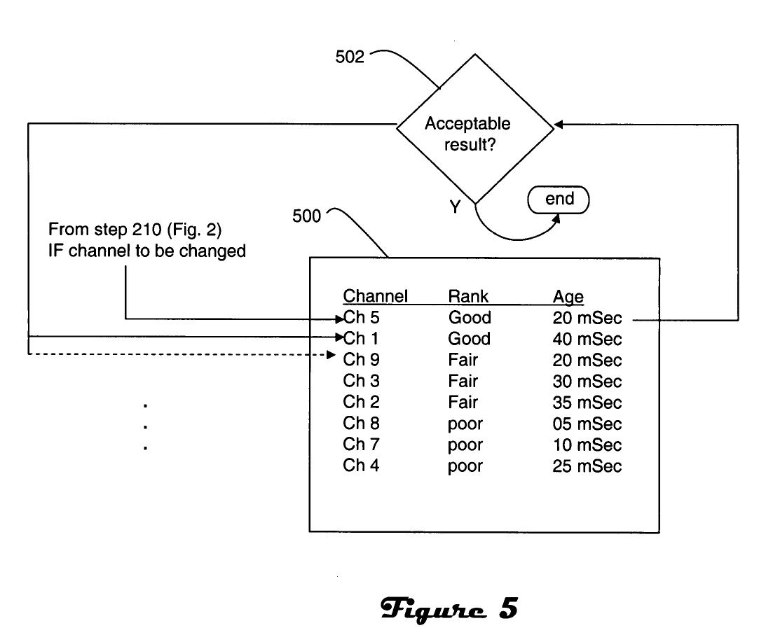

Referring now to FIGS. 2 and 5, when a decision is made to move to a new, different channel, that new channel is selected from a table (500) created by ranking the potential alternate channels as described above. The primary ranking characteristic is the “good,” “fair,” “poor” rankings already described. Good channels are selected before fair channels, which in turn are selected before poor channels. A secondary ranking characteristic is the age of the ranking for the channel. In the illustrated example channels Ch 5 and Ch 1 both have the same rank of “good.” However, channel Ch 5 is preferred relative to channel Ch 1 because Ch 5 was determined to be “good” only 20 mSec ago whereas channel Ch 1 was determined to be “good” 40 mSec ago. Hence, when a determination is made in step (210) to change operating channel, the best ranked channel, e.g., Ch 5, is selected. A determination is then made whether Ch 5 is acceptable as indicated in step (502). The channel may be unacceptable because, for example, interference has adversely effected Ch 5 since it was ranked. If Ch 5 is acceptable then communications are moved to Ch 5 and the selection process ends. If Ch 5 is unacceptable then the next best ranked channel, e.g., Ch 1 is selected and a determination is made whether Ch 1 is acceptable as indicated in step (502). The process continues until an acceptable channel is located.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. For example, while the technique is described in connection with a wireless access point, it could be implemented in various other RF devices, including but not limited to client end stations. Accordingly, the invention should not be viewed as limited except by the scope and spirit of the appended claims.

What is claimed is:

1. A method for coping with interference in a wireless network comprising the steps of:
analyzing a plurality of alternate operating channels;
ranking the alternate operating channels according to interference detected when analyzing the channels; and
if a decision is made to move to an alternate operating channel, selecting the best ranked alternate operating channel.

2. The method of claim 1 wherein, if interference pulse duration is in a range of 61-182 μSec, said step of ranking includes the further step of ranking the channel as being relatively free of interference.

3. The method of claim 1 wherein, if interference pulse duration is in a range of 183-427 μSec, said step of ranking includes the further step of ranking the channel as having interference but being capable of supporting communications.

4. The method of claim 1 wherein, if interference pulse duration is in a range of 428-549 μSec, said step of ranking includes the further step of ranking the channel as having interference but being capable of supporting communications.

5. The method of claim 1 wherein, if interference pulse duration is in a range of 550-1342 μSec, said step of ranking includes the further step of ranking the channel as having interference and being unlikely able to support communications at a reasonable data rate.

6. The method of claim 1 wherein, if interference pulse duration is in a range of 1343-2684 μSec, said step of ranking includes the further step of ranking the channel as having interference and being unlikely able to support communications at a reasonable data rate.

7. The method of claim 1 wherein, if interference pulse duration is in a range of 2685-3660 μSec, said step of ranking includes the further step of ranking the channel as having interference and being unlikely able to support communications at a reasonable data rate.

8. The method of claim 1 wherein, if interference pulse duration is in a range of 3661-8540 μSec, said step of ranking includes the further step of ranking the channel as having interference and being unlikely able to support communications at a reasonable data rate.

9. The method of claim 1 wherein, if interference pulse duration is greater than 8541 μSec, said step of ranking includes the further step of ranking the channel as having interference and being unlikely able to support communications at a reasonable data rate.

10. The method of claim 1 including the further step of rating channels with similar rank in terms of age, such that a channel of a given rank that was most recently analyzed is preferred for selection over other channels of that same rank.

11. The method of claim 1 wherein said step of analyzing alternate operating channels is executed during quiet intervals.

12. The method of claim 1 wherein said step of analyzing alternate operating channels is executed by a parallel demodulation engine.

13. The method of claim 1 including the further step of testing the selected alternate channel, prior to moving communications to that alternate channel, to determine whether that alternate channel is acceptable.

14. The method of claim 13 including the further step of selecting the next best ranked alternate channel if the previously selected channel is determined to be unacceptable.

15. Apparatus operable to mitigate the effects of interference in a wireless network comprising:
processing logic operable to analyze a plurality of alternate operating channels;
processing logic operable to rank the alternate operating channels according to interference detected when analyzing the channels; and
processing logic operable to select the best ranked alternate operating channel if a decision is made to move to an alternate operating channel.

16. The apparatus of claim 15 wherein, if interference pulse duration is in the range of 61-182 μSec, said processing logic operable to rank the alternate operating channel as being relatively free of interference.

17. The apparatus of claim 15 wherein, if interference pulse duration is in the range of 183-427 μSec, said processing logic operable to rank the alternate operating channel as having interference but being capable of supporting communications.

18. The apparatus of claim 15 wherein, if interference pulse duration is in the range of 428-549 μSec, said processing logic operable to rank the alternate operating channel as having interference but being capable of supporting communications.

19. The apparatus of claim 15 wherein, if interference pulse duration is in the range of 550-1342 μSec, said processing logic operable to rank the alternate operating channel as having interference and being unlikely able to support communications at a reasonable data rate.

20. The apparatus of claim 15 wherein, if interference pulse duration is in the range of 1343-2684 μSec, said processing logic operable to rank the alternate operating channel as having interference and being unlikely able to support communications at a reasonable data rate.

21. The apparatus of claim 15 wherein, if interference pulse duration is in the range of 2685-3660 μSec, said processing logic operable to rank the alternate operating channel as having interference and being unlikely able to support communications at a reasonable data rate.

22. The apparatus of claim 15 wherein, if interference pulse duration is in the range of 3661-8540 μSec, said processing logic operable to rank the alternate operating channel as having interference and being unlikely able to support communications at a reasonable data rate.

23. The apparatus of claim 15 wherein, if interference pulse duration is greater than 8541 μSec, said processing logic operable to rank the alternate operating channel as having interference and being unlikely able to support communications at a reasonable data rate.

24. The apparatus of claim 15 further including processing logic operable to rate channels with similar rank in terms of age, such that a channel of a given rank that was most recently analyzed is preferred for selection over other channels of that same rank.

25. The apparatus of claim 15 wherein said processing logic operable to analyze alternate operating channels is further operable to gather data during quiet intervals.

26. The apparatus of claim 15 further including a parallel demodulation engine, and wherein the processing logic operable to analyze alternate operating channels is further operable top gather data via the parallel demodulation engine.

27. The apparatus of claim 15 further including processing logic operable to test the selected alternate channel prior to moving communications to that alternate channel in order to determine whether that alternate channel is acceptable.

28. The apparatus of claim 27 wherein the processing logic operable to test the selected alternate channel is further operable to selecting the next best ranked alternate channel if the previously selected channel is determined to be unacceptable.
